(19) United States
(12) Patent Application Publication
(10) Pub. No.: US 2022/0246163 A1
(43) Pub. Date: Aug. 4, 2022

(54) TECHNOLOGIES FOR SYNCRONIZING RENDERING OF MULTI-CHANNEL AUDIO

(71) Applicant: ARRIS Enterprises LLC, Suwanee, GA (US)

(72) Inventors: Christopher DELSORDO, Souderton, PA (US); Albert F. ELCOCK, West Chester, PA (US); Richard MOORE, JR., Harleysville, PA (US); Cesar A. MORENO, Santa Rosa Beach, FL (US)

(73) Assignee: ARRIS Enterprises LLC, Suwanee, GA (US)

(21) Appl. No.: 17/575,960

(22) Filed: Jan. 14, 2022

Related U.S. Application Data
(60) Provisional application No. 63/143,161, filed on Jan. 29, 2021.

(51) Int. Cl. G10L 21/055; H04R 29/00; H04L 65/60

(52) U.S. Cl. CPC G10L 21/055; H04L 65/601; H04R 29/001

(57) ABSTRACT

Technologies are disclosed for synchronously rendering audio content by a plurality of network connected speakers. In various embodiments, a media control device may receive media content comprising an audio component, the device may derive and transmit instructions for buffering and rendering the audio component to a plurality of speakers, wherein the instructions include instructions for synchronizing a rendering clock comprised within each of the more than one speakers. The device may transmit the audio component to the more than one speaker of the plurality of speakers; while monitoring status information transmitted by the plurality of speakers; and maintain or restore synchronous rendering of the audio component by the plurality of speakers in response to the status information received from the speakers.

### BACKGROUND

Media content may be provided by a plurality of media content network operators to home and/or business subscribers/viewers. Media content network operators (e.g., cable network operators, satellite operators, etc.) may provide subscribers/viewers with various forms of media content, such as movies, concerts, premium media content, broadcast media content, OTT application, social media and video conference media content, and/or pay-per-view (PPV) media content, and/or the like. Third-party network content network providers may also provide content to subscribers over the networks operated by network operators.

At times, a user may view/listen to media content at a device, such as a mobile/wireless device (e.g., a cellphone, and/or a tablet, etc.), or at other, more stationary, devices (e.g., desktop computer, gaming device, set-top box, and/or a television, etc.) perhaps while connected to a home and/or private communication network, or perhaps while the user is away from the home/private network and obtaining the media content from the Internet. The media content may include video content and audio content. The one or more devices with which the user may view/listen to the media content may process other video and/or audio signals/content, perhaps in addition to and/or simultaneously with, the video/audio of the media content.

Whole Home Audio systems are becoming more common as audio content formats evolve along with the ability to stream audio from multiple sources over both the WAN and LAN networks using various wireless technologies. High end Wi-Fi speaker manufacturers are on the rise whose products render these more advanced audio codec formats for advanced surround sound audio.

### SUMMARY

Both whole home audio solution providers and speaker manufacturers are working together to enhance the consumers listening experience in variety of ways. Surround sound speaker systems exist today where each device may render one or more audio channels depending on the configuration. The content could be music services or audio coupled with video. A network connected surround-sound systems can comprise multiple speakers that each renders an audio channel in accordance with the physical arrangement of the speakers. For example in a 5.1 system, the channels may be front right, front center, front left, back left, back right, and a sub-woofer channel. Other systems may have more or fewer channels. In various designs, a system may comprise a mixture of wired and wireless speakers using a combination of audio cables, wired Ethernet, and wireless connections (e.g., Wi-Fi, Bluetooth, or another radio protocol) to deliver audio signals to each speaker. Each network-connected audio device renders one or more specific audio channel(s) depending on the arrangement of the system. Wireless based surround sound systems that group multiple speakers present significant challenges due to non-deterministic transmission times. Today technologies exist to discover and group speakers in a group. The discovery process provides information on the rendering characteristics of the speaker. We will make use of these existing technologies.

Technologies are disclosed for synchronizing audio one or more audio components/sessions of media content that may be performed by a media control device. The media control device may be in communication with one or more speakers. The media control device may receive media content having an audio component. The media control device may transmit instructions and data to a plurality of speakers, at least some of which are connected to the media control device via a network connection. The data may comprise an encoded audio component which may be made up of one or more audio channels. In exemplary embodiments, the network is local area network (LAN) comprising, for example, Wi-Fi and/or Ethernet connections, and the media control devices are connected to the same LAN as the speakers.

In one or more scenarios, an audio component is transmitted to at least a first speaker and a second speaker, each transmission of the audio component to each speaker being associated with instructions for rendering one or more channels within the audio component, where the instructions to each speaker can comprise data for synchronizing the rendering of the audio component by the speaker with one or more other speakers. In one or more scenarios, a first audio sub-component (or channel) may be assigned to at least the first speaker and a second audio sub-component may be assigned to at least the second speaker of the one or more speakers.

### BRIEF DESCRIPTION OF DRAWINGS

The elements and other features, advantages and disclosures contained herein, and the manner of attaining them, will become apparent and the present disclosure will be better understood by reference to the following description of various examples of the present disclosure taken in conjunction with the accompanying drawings, wherein:

FIG. 1 is a block diagram illustrating an example network environment operable to deliver video and/or audio content throughout the network via one or more network devices, such as a consumer premises device (CPE) device and a plurality of speakers.

FIG. 2 is a block diagram illustrating an example CPE device of FIG. 1 that may be configured to deliver video and/or audio content to a subscriber.

FIG. 3 is an example flow diagram of at least one technique for managing one or more audio components/sessions of synchronous media content.

FIG. 4 is a block diagram of a hardware configuration of an example device that may deliver video and/or audio content, such as the CPE device of FIG. 2.

### DETAILED DESCRIPTION

A solution to the problem of synchronizing audio rendering in a system comprising a plurality of network connected speakers can comprise incorporating aspects of the functionality described below into a media control device and into network-connected speakers, for example by use of a software development kit (SDK). In some of the examples that follow, a media control device may be designated as an Audio Source Device (AudSource) and a network-connected speaker may be designated as an Audio Sync Device (AudSync).

In exemplary embodiments, the AudSource can request, receive, and process an incoming streaming service request comprising an audio component and derive and transmit audio streaming configuration information to the AudSync devices. The AudSource can coordinate the streaming session control requests of the AudSource device with simultaneous streaming session control requests for each AudSync device. Each AudSync device can receive data comprising control instructions and encoded audio components to render the audio component or a sub-component thereof and may transmit status information to the AudSource device that can include one or more of the following, an amount of audio data stored in a buffer, time data associated with receipt of packets of data, time data associated with rendering of audio data. The AudSource device can receive and process the status information transmitted by each AudSync device and process the status information to derive parameters governing the timing of transmission of packets of audio component data to each AudSync Device and to derive instructions for timing the rendering of audio data by each AudSync Device.

In embodiments in which an audio content component comprises a plurality of audio sub-components, e.g., stereo or surround-sound audio components, the AudSource can assign specific audio channel assignments for each speaker in the group. In exemplary embodiments, the AudSource can duplicate a complete audio profile source for each streaming session. In these embodiments, the AudSource can send the entire profile to each AudSync device. The AudSource can thereby ensure that it does not alter the transmission rate to different AudSync devices. In some embodiments, each AudSync device may transmit a profile defining its network and audio rendering capabilities to the AudSource. The AudSource device will learn the capabilities of each AudSync in the group and use this information to define each group member's responsibility for filtering and rendering its audio content.

The AudSource will orchestrate the speed of rendering for each AudSync via configuration sent prior to the start of rendering so that each group member can render at the same time and to be sure each device maintains a constant buffer level. It will also be responsible to monitor each AudSync's synchronization status and to determine if a group member is out of sync. The AudSource will take corrective action if it determines that one or more AudSync device is out of synch with one or more other AudSync devices.

In some embodiments, a sequential audio content identification mechanism is associated with the stream of audio data being transmitted by the AudSource. Upon initialization of an audio streaming session, audio packet identifiers can coordinated across the streaming sessions. In exemplary embodiments, the audio packets utilized for an audio streaming session may conform to uniform format parameters, for example the packet size and timestamps may be identical across sessions.

In some embodiments, the AudSource will control the simultaneous streaming sessions and send the data at the same rate to each AudSync device. The AudSource may be configured to send the same data to each AudSync at the same time. For example, the AudSource may use http unicast transmission over TCP/IP sockets for each streaming session to an AudSync device.

In various embodiments, the AudSource and AudSync may utilize a Buffer Id together with AudSync rendering clock synchronization to provide for synchronous rendering of the audio content by each AudSync.

In various embodiments, a processor of the AudSource may transmit data and/or instructions to configure each AudSync's rendering clock which will be used to know when to render audio packets that are received by each AudSync and buffered within a memory of each AudSync. This information may be broadcast or provided individually to each AudSync participating in the group. In various embodiments, the processor of the AudSource may derive configuration parameters from the Audio Codec used in the streaming session, optionally in conjunction with network performance and AudSync device properties. In various embodiments, each AudSync will render assigned audio sub-components (i.e., channels) with same audio packet identifications at the same time provided by the clock.

In various embodiments, a processor of the AudSource may use device discovery capabilities that are known to persons of ordinary skill in the art. In various embodiments, a processor of the AudSource may continuously monitor AudSync devices as they are discovered and leave the group. For example, a processor of an AudSource may periodically transmit a request for AudSync devices that are connected to the same local network to report identifying information. Each AudSync that receives such a request may respond with a device Id and optionally additional information regarding the capabilities and status of the device.

The AudSource may thus obtain information from the discovered speakers about its capabilities. A processor of the AudSource may use this information to determine an audio channel assignments, for example, accordance with the number of speakers discovered. The AudSource may provide instructions to each AudSync to select specific channels to render from the full audio content. In various embodiments, Wi-Fi proximity detection methods may be used to determine the distance of each AudSync from the AudSource to aide in audio channel assignment. In some embodiments, discovery and group assignment of AudSync devices may be performed prior to the start of each streaming session.

In various embodiments, a processor of the AudSource may use audio codec and sample rate information from the streaming session request to derive audio streaming configuration information that can be transmitted to each AudSync device prior to the start of a simultaneous streaming session. In various embodiments, a processor of an AudSource may dynamically change some or all of this information during the streaming session and transmit changed configuration instructions to affected AudSync devices. The following steaming session configuration parameters may be included in configuration information that is transmitted to an AudSync device: a number of audio packets to pre-fetch, audio profile Information, an audio channel assignment for each AudSync device, rendering information (e.g., timing, rate, volume, etc.), and AudSync device rendering clock configuration instructions.

In various embodiments, a processor of the AudSource may coordinate the same control and commands across the streaming sessions to the AudSync devices. For example, a processor of the AudSource may transmit commands for simultaneous start, stop, and pause of each AudSync. The AudSource may monitor each AudSync's status and synchronization states.

In various embodiments, it may be advantageous to ensure sure that enough data is fetched well ahead of time so that any variations of the network transmission time, e.g., due to variations in a wireless channel, can be accommodated without losing synchronization. An AudSource may configure, monitor, and adjust the amount of buffered data prior to AudSync rendering. In various embodiments, the AudSource will determine and/or monitor network transmission time periodically between the AudSource and each AudSync in the group. Each AudSync may transmit a data packet upon receipt of audio data indicating the time that the data was received and/or the current amount to audio content data stored in a buffer in memory of the AudSync device. In various embodiments, a processor of the AudSource will also use the audio format information (e.g., sample rate) to in determining buffering requirements. Network transmission time could vary for each AudSync and an AudSource may adjust data transmission and buffering requirements for each AudSync separately or as a group. For example, network transmission time for an individual AudSync may be used by a processor of the AudSource to determine an audio buffer depth to be maintained and pace the data between the AudSource and AudSync. The AudSource may have to adjust the flow of content between the source and sync if network speeds change. In various embodiments, it may be advantageous to combine the use of pacing, identification of buffered data being transferred and clock synchronized rendering as a means of making sure all audio channels are rendered at the same time.

In various embodiments, it may be advantageous for an AudSource to configure and an AudSync to perform pre-fetching of audio buffer content prior to starting a streaming session. A processor of the AudSource may calculate the required pre-fetch buffer size and the continuous AudSync buffer size based on the network transmission speed and the audio code format. Each AudSync can then transmit status data to the AudSource as it is processing the audio stream. Information included in the status will allow the AudSource the ability to determine if the AudSync is retendering its audio channel in sync with the other AudSync devices.

In various embodiments, it may be advantageous for an AudSource to determine if the amount of data in an AudSync's buffer has fallen below a threshold value, for example an amount calculated to provide for continuous synchronous streaming under current network conditions. A minimum buffered data level may be established based on current network transmission speed, audio format sample rate, audio rendering clock speeds, etc. If the amount of buffered data in memory of an AudSync device gets too low, a processor of an AudSource may take corrective action to get the AudSync back in sync. For example, an AudSource may increase or decrease the rate of data transmission to an AudSync in response changes in network transmission time. In the event that synchronization is lost, an AudSource may provide instructions to one or more AudSync devices to restore synchronization of audio rendering. In various embodiments, an AudSource will monitor for disconnection of an AudSync and take corrective action to re-stablish a synchronous audio streaming session.

In various embodiments, it may be advantageous for an AudSource to re-establish an AudSync's streaming session from a specific time point in the audio content. The AudSource may transmit the latest buffer id that is simultaneously being fed to the other AudSyncs to an out-of-sync AudSync and configuration information for re-establishment will be provided when the streaming session is re-established to indicate the starting buffer id to render. For example, the AudSource may skip sending some data to an out-of-sync AudSync to refill a buffer with current data and transmit instructions to configure a rendering clock of the out-of-sync AudSync to restart rendering audio data corresponding to a current buffer Id in synchrony with other AudSync devices.

For the purposes of promoting an understanding of the principles of the present disclosure, reference will now be made to the examples illustrated in the drawings, and specific language will be used to describe the same. It will nevertheless be understood that no limitation of the scope of this disclosure is thereby intended.

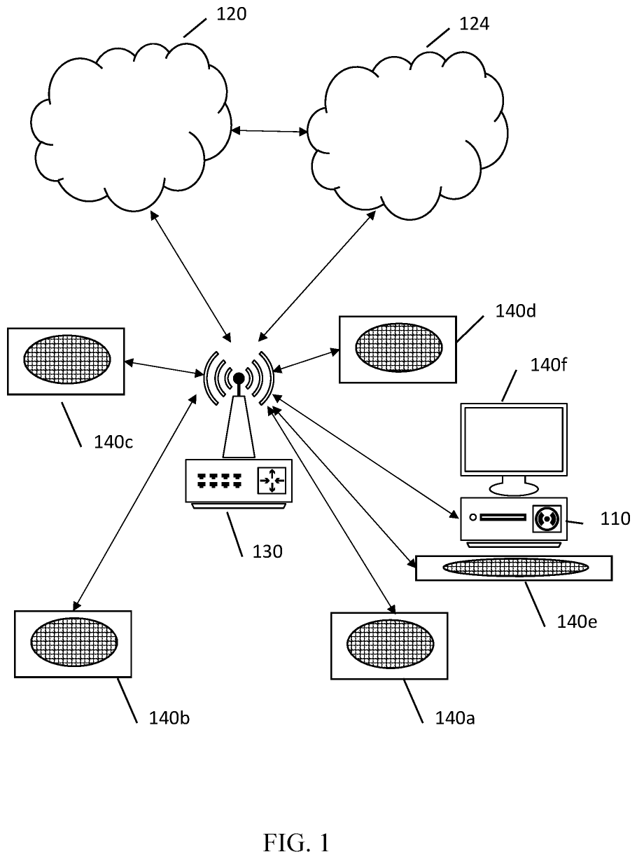

FIG. 1 is a block diagram illustrating an example network environment 100 operable for a media content delivery network operator, or MSO, to deliver media content to subscribers/viewers. Media content may be provided via a consumer premise equipment (CPE) and/or network gateway device supported by the MSO, for example. In one or more scenarios, CPE device 110 receive audio/video service(s) and/or data service(s) from a wide area network (WAN) 120 via a connection to a subscriber network 130. The one or more nodes of subscriber network 130 and/or the WAN 120 may communicate with one or more cloud-based nodes (not shown) via the Internet 124. The subscriber network 130 may include a home gateway including a wireless access point.

CPE devices 110 can include, for example, a modem, a set-top box, a wireless router including an embedded modem, or a media gateway, among many others (e.g., digital subscriber line (DSL) modem, voice over internet protocol (VOIP) terminal adapter, video game console, digital versatile disc (DVD) player, communications device, hotspot device, etc.). The subscriber network 130, for example, could be a local area network (LAN), a wireless local area network (WLAN), a mesh network, as well as others.

CPE devices 110 can facilitate communications between the WAN 120 and audio/visual devices such as a smart TV 140f and plurality of speakers 140a-140e. One or more speaker devices (e.g., sound radiation devices/systems) 140a-140e may be in communication through and with the Subscriber Network 130, set-top box, and/or television, etc.

The one or more speaker devices 140a-140e (e.g., surround sound speakers, home theater speakers, other external wired/wireless speakers, loudspeakers, full-range drivers, subwoofers, woofers, mid-range drivers, tweeters, coaxial drivers, etc.) may broadcast at least an audio component of media content, among other audio signals/processes/applications. The one or more speaker devices 140a-e may possess the capability to radiate sound in pre-configured acoustical/physical patterns (e.g., a cone pattern, a directional pattern, etc.)

A user (not shown) may monitor (e.g., watch and/or listen to) media content on/from one or more of the devices 140a-140f, among other devices (not shown), for example. The WAN network 120 and/or the subscriber network 130 may be implemented as any type of wired and/or wireless network, including a local area network (LAN), a wide area network (WAN), a global network (the Internet), etc. Accordingly, the WAN network 120 and/or the subscriber network 130 may include one or more additional communicatively coupled network computing devices (not shown) for facilitating the flow and/or processing of network communication traffic via a series of wired and/or wireless interconnects. Such network computing devices may include, but are not limited, to one or more access points, routers, switches, servers, compute devices, storage devices, etc.

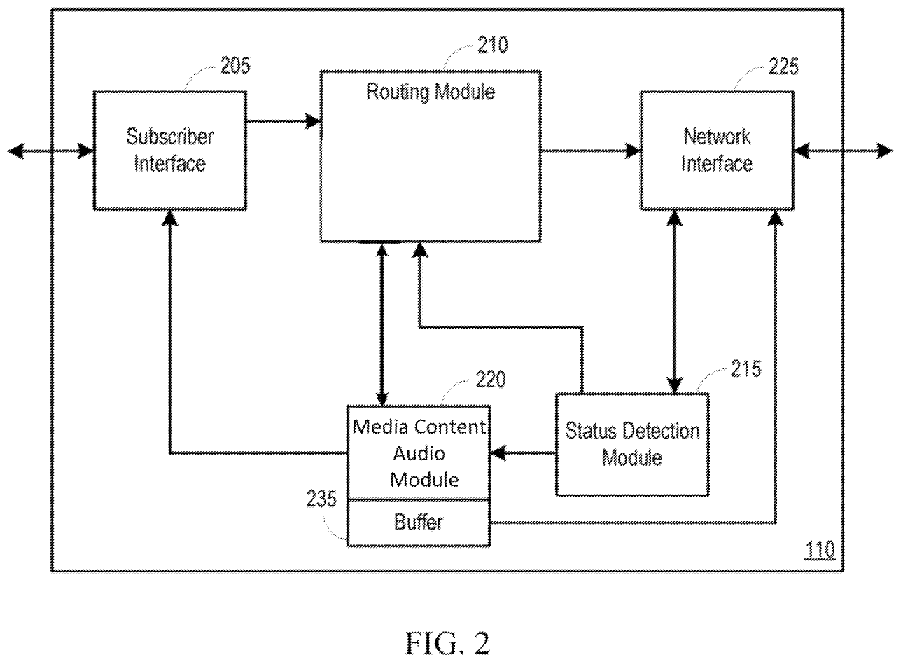

FIG. 2 is a block diagram illustrating an example CPE device 110 operable to output audio/visual media content to one or more devices. The CPE device 110 can include a subscriber interface 205, a routing module 210, a status detection module 215, a media content audio module 220, and/or a network interface 225. The subscriber interface 205 may include input and output functions, for example input functions for receiving subscriber commands and output functions for rendering audio/visual content, menus, etc. on a device such as TV 140f.

In one or more scenarios, the CPE device 110 may receive a communication from a subscriber or subscriber device. In one or more scenarios, a routing module 210 may route a received communication to a network interface 225. The routing module 210 may route the communication to the network interface 225. The routing module may translate the received communication from a URL to an IP address.

In one or more scenarios, a user may assign components of media content to selected/determined/designated speaker device(s) in a multi-speaker network (e.g., in a home setting, business setting, etc.). In one or more scenarios, the CPE device 110 (e.g., an AudSource) can be configured to automatically select one or more speakers for each audio component or sub-component. In one or more scenarios, for example, a surround sound home theater system may be in communication with a device. The user may select/assign/pin one or more speakers (e.g., AudSync devices) of the surround sound system to different audio channels that may be provided via different speakers of the surround sound system in accordance with the physical arrangement of the system. The AudSource can then manage the synchronous rendering of selected audio content by each AudSync device. For example, using the examples described herein, any of the devices 140a-140e that may be in a surround sound speaker system, and the video program audio component may be provided via the one or more speakers of the surround sound speaker system in the typical surround sound way.

In one or more scenarios, a media content audio module 220 may be configured to manage one or more audio components/sessions of media content. Synchronous rendering of audio content may be performed by one or more of the devices 140a-140e (e.g., AudSync devices). The media content audio module 220 may be configured to, in conjunction with the Status Detection Module, discover the AudSync devices, and receive information regarding the capabilities and status of the AudSync devices and the subscriber's home network. The media content audio module 220 may be configured to assign/select/pin a first audio channel to at least a first speaker of the one or more speakers. In one or more scenarios, the media content audio module 220 may be configured to assign/select/pin the second audio channel to at least the second speaker of the one or more speakers. The media content audio module 220 may be configured to determine and transmit instructions and data through the routing module and network interface for the synchronous rendering of audio content by the AudSync devices.

A routing module 210 can route communications, requests, determinations, and/or detections of audio component/session assignments to/from the media content audio module 220. For example, the routing module 210 can translate the communications, requests, determinations, and/or detections of audio component/session assignments into and/or with an address (e.g., IP address) associated with the media content audio module 220. A status detection module 215 may monitor the network connection status of the CPE device 110.

The status detection module 215 can monitor the network connection of the CPE device 110 through the network interface 225. The status detection module 215 can monitor the status of the network and/or data link layer associated with the CPE device 110. For example, the status detection module 215 can monitor the CPE device's connection to a host server (e.g., dynamic host configuration protocol server) and/or the status of configuration information received from the host server. The status detection module 215 can monitor one or more various components that are associated with the network connection for the CPE device 110. The status detection module 215 may determine the status of the network connection between the CPE device 110 and audio/visual devices 140 and may receive status information from those devices regarding the amount of buffered data, and the rendering of audio/visual content. The communications, requests, determinations, and/or detections of the audio component/session assignments may be transmitted and/or stored in one or more files, such as text files (e.g., Hypertext Transfer Protocol (HTTP) files), among other type of files.

The media content audio module 220 may include a buffer 235. The CPE device 110 may store one or more, or multiple, files in buffer 235 that may be ordered (e.g., hierarchically according to a specific order) for carrying out one or more actions. For example, buffer 235 may contain time-ordered audio/visual content to be transmitted to one or more audio/visual devices 140 for rendering. The buffer 235 can also store a subscriber communication (e.g., URL or IP address received from the subscriber) and/or the communications, requests, determinations, and/or detections of audio component/session assignments.

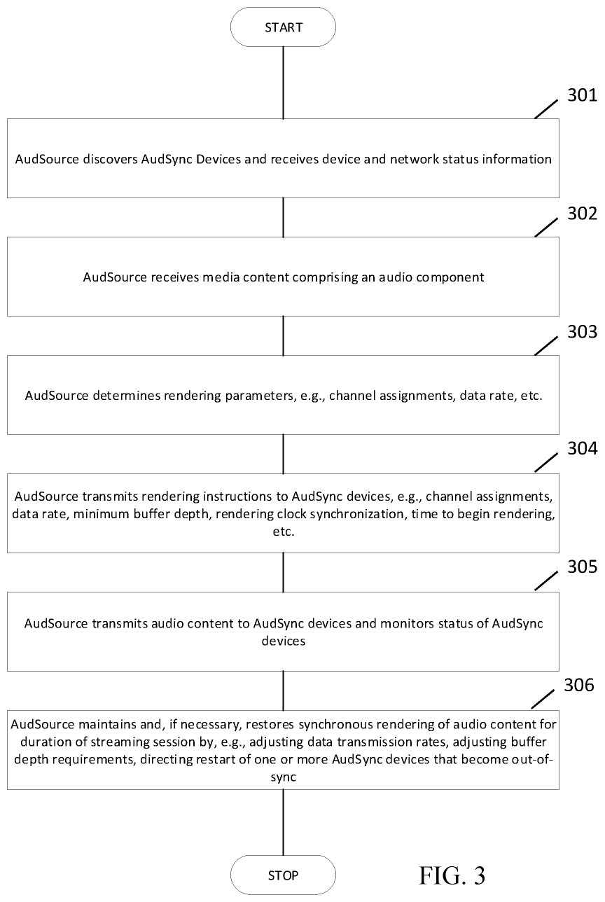

Referring now to FIG. 3, an example method 300 illustrates a technique for managing one or more audio components/sessions of media content that may be performed by an AudSync.

In step 301, the AudSource may discover a plurality of AudSync devices and receives device and network status information. In step 302, the AudSource may receive media content comprising at least an audio component. The audio component may comprise one or more sub-components (e.g., channels) that should be rendered by different speakers or the same audio may be rendered on each of several speakers simultaneously. In step 303, the processor of the AudSource determines how to render the audio component based on the media content (codec, data rate, number of channels) and the network configuration (network speed, device capabilities, etc.). In step 304, the AudSource transmits rendering instructions to the AudSync devices, including instruction for synchronizing rendering clocks, a buffer depth to maintain, time to begin rendering, etc. In step 305, AudSource transmits the audio content to the AudSync devices and monitors the status of the AudSync devices. Typically, the audio content will be encoded in data and divided into sequential chunks/packets, each chunk associated with a buffer ID indicating the order and time that a chunk should be rendered. The same audio content may be transmitted to each of the AudSync devices where each of the AudSync devices have been instructed to extract and render designated sub-components (i.e., channels). While AudSource is transmitting audio content, it is also monitoring status messages received from each AudSync that may indicate, for example, the buffer depth of the AudSync device, the currently rendered chunk, the time that a packet/chunk is received, etc. In step 306, AudSource maintains and, if necessary, restores synchronous rendering by adjusting the data transmission rate, adjusting the rendering and buffering instructions to AudSync devices, and, if necessary, restarting rendering by an AudSync at a defined time point to restore synchronous rendering by the group of AudSync devices.

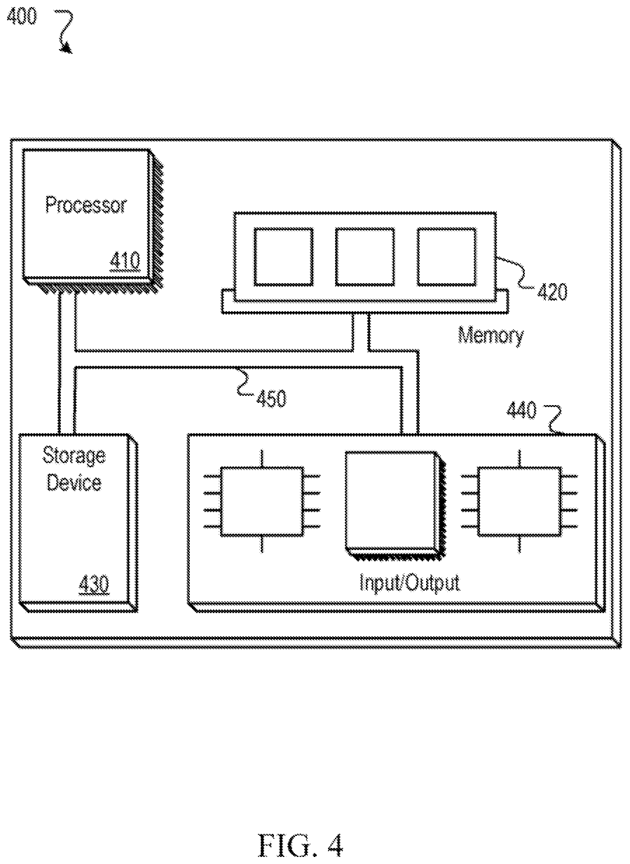

FIG. 4 is a block diagram of a hardware configuration of an example device that may deliver media content (e.g., video and/or audio content), such as the CPE device of FIG. 2. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be capable of processing instructions stored in the memory 420 and/or on the storage device 430.

The memory 420 can store information within the hardware configuration 400. The memory 420 can be a computer-readable medium (CRM), for example, a non-transitory CRM. The memory 420 can be a volatile memory unit. The memory 420 can be a non-volatile memory unit.

The storage device 430 can be capable of providing mass storage for the hardware configuration 400. The storage device 430 can be a computer-readable medium (CRM), for example, a non-transitory CRM. The storage device 430 can, for example, include a hard disk device, an optical disk device, flash memory and/or some other large capacity storage device. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and receive communications from one or more networks (e.g., subscriber network 120 of FIG. 1).

Those skilled in the art will appreciate that the disclosed subject matter improves upon methods and/or apparatuses for mitigating audio clarity issues that may arise while monitoring more than one media content, where the media content may have their own audio components/sessions. This may be useful in one or more scenarios, for example with devices that may be used to monitor media content and that may be communication with more than one speaker.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. The subject matter described in this specification can be implemented as one or more computer program products, e.g., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and/or logic flows described in this specification may be performed by one or more programmable processors executing one or more computer programs to perform functions by operating on input data and/or generating output thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

While this specification contains many specific implementation details, these should not be construed as limitations on the scope of any invention or of what may be claimed, but rather as descriptions of features that may be specific to described implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and perhaps even initially claimed as such, one or more features from a claimed combination can in some cases be excised from the combination, and the claimed combination may be directed to a sub-combination or variation of a sub-combination.

While operations may be depicted in the drawings in a particular order, this should not be understood as requiring that such operations be performed in the particular order shown or in sequential order, or that all illustrated operations be performed, to achieve desirable results. The described program components and/or systems can generally be integrated together in a single software product or packaged into multiple software products.

Examples of the subject matter described in this specification have been described. The actions recited in the claims can be performed in a different order and still achieve desirable results, unless expressly noted otherwise. For example, the processes depicted in the accompanying figures do not necessarily require the particular order shown, or sequential order, to achieve desirable results. Multitasking and parallel processing may be advantageous.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A method for synchronously rendering audio components of media content performed by a media control device, the media control device being in communication with a plurality of speakers, the method comprising:
receiving media content, by the media control device, the media content having at least an audio component;
transmitting, by the media control device, instructions for buffering and rendering the audio component to more than one speaker of the plurality of speakers, wherein the instructions include instructions for synchronizing a rendering clock comprised within each of the more than one speakers;
transmitting, by the media control device, the audio component to the more than one speaker of the plurality of speakers;
monitoring, by the media control device, status information transmitted by the more than one speaker of the plurality of speakers; and
maintaining or restoring, by the media control device, synchronous rendering of the audio component by the more than one speakers of the plurality of speakers.

2. The method of claim 1, wherein maintaining or restoring synchronous rendering of the audio component by the more than one speakers of the plurality of speakers comprises adjusting a rate of data transmission to one or more of the plurality of speakers.

3. The method of claim 1, wherein maintaining or restoring synchronous rendering of the audio component by the more than one speakers of the plurality of speakers comprises transmitting, by the media control device, revised instructions for buffering and rendering the audio component to more than one speaker of the plurality of speakers.

4. The method of claim 1, wherein maintaining or restoring synchronous rendering of the audio component by the more than one speakers of the plurality of speakers comprises transmitting, by the media control device, to at least one of the more than one speakers, instructions for restarting rendering of the audio component at a defined time point.

5. The method of claim 1, wherein the audio component comprises a plurality of channels and transmitting, by the media control device, instructions for rendering the audio component to of the plurality of speakers comprises instructing different speakers to render different channels of the audio component.

6. The method of claim 5, wherein transmitting, by the media control device, the audio component to the more than one speaker comprises transmitting the entire audio component comprising the plurality of channels to each of the more than one speakers.

7. The method of claim 1, wherein monitoring, by the media control device, status information transmitted by the more than one speaker of the plurality of speakers comprises receiving, from each of the more than one speakers, one or more of 1) a clock time and buffer ID of last rendered audio data, 2) an amount of data stored in a buffer comprised in the speaker, and 3) a time that data transmitted by the media control device was received by the speaker.

8. A media control device configured to provide media content, the media control device being in communication with a plurality of speakers, the device comprising:
a memory;
a transceiver; and
a processor, the processor configured at least to:
receive media content having at least an audio component;
transmit instructions for buffering and rendering the audio component to more than one speaker of the plurality of speakers, wherein the instructions include instructions for synchronizing a rendering clock comprised within each of the more than one speakers;
transmit the audio component to the more than one speaker of the plurality of speakers;
monitor status information transmitted by the more than one speaker of the plurality of speakers; and
maintain or restore synchronous rendering of the audio component by the more than one speakers of the plurality of speakers.

9. The device of claim 8, wherein the processor is configured to adjust a rate of data transmission to one or more of the plurality of speakers to maintain or restore synchronous rendering of the audio component by the more than one speakers of the plurality of speakers.

10. The device of claim 8, wherein the processor is configured to transmit revised instructions for buffering and rendering the audio component to more than one speaker of the plurality of speakers to maintain or restore synchronous rendering of the audio component by the more than one speakers of the plurality of speakers comprises.

11. The device of claim 8, wherein the processor is configured to at least one of the more than one speakers, instructions for restarting rendering of the audio component at a defined time point to restore synchronous rendering of the audio component by the more than one speakers of the plurality of speakers.

12. The device of claim 8, wherein the processor is configured to transmit instructions to different speakers to render different channels of the audio component based at least on: capabilities associated with individual speakers of the plurality of speakers, and a relationship between a number of speakers in a speaker group and a number of channels in the audio component.

13. The device of claim 12, wherein the processor is configured to transmit the entire audio component comprising a plurality of channels to each of the more than one speakers.

14. The device of claim 8, wherein the processor is configured to receive, from each of the more than one speakers, data comprising one or more of 1) a clock time and buffer ID of last rendered audio data, 2) an amount of data stored in a buffer comprised in the speaker, and 3) a time that data transmitted by the media control device was received by the speaker; and to use the data to maintain or restore synchronous rendering of the audio component by the more than one speakers.

15. A non-transitory computer readable medium having instructions stored thereon, the instructions causing at least one processor of a media control device to perform one or more operations, the media control device being in communication with a plurality of speakers, the one or more operations comprising at least:
receiving media content, by the media control device, the media content having at least an audio component;
transmitting, by the media control device, instructions for buffering and rendering the audio component to more than one speaker of the plurality of speakers, wherein the instructions include instructions for synchronizing a rendering clock comprised within each of the more than one speakers;
transmitting, by the media control device, the audio component to the more than one speaker of the plurality of speakers;
monitoring, by the media control device, status information transmitted by the more than one speaker of the plurality of speakers; and
maintaining or restoring, by the media control device, synchronous rendering of the audio component by the more than one speakers of the plurality of speakers.

16. The non-transitory computer readable medium of claim 15, wherein maintaining or restoring synchronous rendering of the audio component by the more than one speakers of the plurality of speakers comprises adjusting a rate of data transmission to one or more of the plurality of speakers.

17. The non-transitory computer readable medium of claim 15, wherein maintaining or restoring synchronous rendering of the audio component by the more than one speakers of the plurality of speakers comprises transmitting, by the media control device, revised instructions for buffering and rendering the audio component to more than one speaker of the plurality of speakers.

18. The non-transitory computer readable medium of claim 15, wherein maintaining or restoring synchronous rendering of the audio component by the more than one speakers of the plurality of speakers comprises transmitting, by the media control device, to at least one of the more than one speakers, instructions for restarting rendering of the audio component at a defined time point.

19. The non-transitory computer readable medium of claim 15, wherein the audio component comprises a plurality of channels and transmitting the audio component comprises transmitting the entire audio component to each of the more than one speakers, and transmitting instructions for rendering the audio component to of the plurality of speakers comprises instructing different speakers to render different channels of the audio component.

20. The non-transitory computer readable medium of claim 15, wherein monitoring, by the media control device, status information transmitted by the more than one speaker of the plurality of speakers comprises receiving, from each of the more than one speakers, one or more of 1) a clock time and buffer ID of last rendered audio data, 2) an amount of data stored in a buffer comprised in the speaker, and 3) a time that data transmitted by the media control device was received by the speaker.
